(19) United States
(12) Patent Application Publication
(10) Pub. No.: US 2025/0352944 A1
(43) Pub. Date: Nov. 20, 2025

(54) SYSTEM AND METHOD FOR CAPTURING AND CONVERTING GREENHOUSE GASES

(71) Applicant: EINSTED CORPORATION, Wilmington, DE (US)

(72) Inventors: Valeria ROMERO, Buenos Aires (AR); Isaac RODRIGUEZ, Buenos Aires (AR); Angela SILES, Buenos Aires (AR); Gabriel ESQUIVEL, Buenos Aires (AR); Nahuel OLAIZ, Buenos Aires (AR)

(21) Appl. No.: 18/866,459

(22) PCT Filed: May 16, 2023
(86) PCT No.: PCT/US2023/022425

§ 371 Date: Nov. 15, 2024

Related U.S. Application Data
(60) Provisional application No. 63/364,787, filed on May 16, 2022.

(51) Int. Cl. B01D 53/22; B01D 53/30; B01D 53/32; C25B 9/00

(52) U.S. Cl. CPC B01D 53/229; B01D 53/228; B01D 53/30; B01D 53/32; B01D 2257/504; B01D 2257/7025; B01D 2258/06; B01D 2259/818; C25B 9/00

(57) ABSTRACT

A novel artificial intelligence system and device consisting of a high-electric field nano-pulse generator has been developed. Also, an assembled arrangement with nanomembrane and electrodes, and this previous device is proposed. In general terms, this new technology can be used to capture and convert carbon dioxide, methane or other greenhouse gases, to a broad range of carbon-based compounds and hydrogen. Also, this invention relates to an electrochemical cell that has specific and novel properties associated with new membrane-electrodes assemblies. Preferably, these assemblies associated with high electric fields provide specific conditions for greenhouse gases capturing and conversion in selective and efficient ways. In particular, these conditions are related to the commonly known plasma technology. This invention includes the purification steps before and after of the greenhouse gas conversion cell, called nano-filters. Therefore, a carbon capture artificial intelligence system, method, and device are proposed.

### TECHNICAL FIELD

The embodiments described herein are generally directed to capturing and converting greenhouse gases from the atmosphere to industrially valuable products, and, more particularly, to processes and systems for converting carbon dioxide or methane in the gas phase into solid carbon, oxygen, or hydrogen from the atmosphere (either gas or liquid) to industrially valuable products.

### BACKGROUND

Global warming is one of the most important issues that mankind faces today. The need to solve what to do with the gasses produced by the use of fossil fuels is urgent, as is the need to replace fossil fuels with hydrogen and develop certified sustainable processes to obtain such hydrogen. Greenhouse gas emissions, such as carbon dioxide, methane, and nitrous oxide, are a major contributor to climate change and global warming. The burning of fossil fuels, deforestation, and industrial processes are the primary sources of greenhouse gas emissions.

In recent years, the world has witnessed a steady increase in global temperatures, rising sea levels, and extreme weather events, all of which can be attributed to the accumulation of greenhouse gases in the atmosphere. To combat this issue, various measures have been proposed to reduce greenhouse gas emissions. These measures include the use of renewable energy sources, energy-efficient technologies, and the implementation of carbon capture and storage (CCS) techniques. CCS is the process of capturing carbon dioxide emissions from power plants and industrial processes and storing them underground, where they can be stored safely and prevented from entering the atmosphere.

While CCS is an effective technique for reducing greenhouse gas emissions, the captured gases can also be converted into useful industrial products, such as synthetic fuels, plastics, and chemicals. This process, known as carbon capture and utilization (CCU), not only reduces greenhouse gas emissions but also creates a new revenue stream for industries.

Therefore, there is a need for innovative technologies that can effectively capture and convert greenhouse gas emissions into useful industrial products. The present invention addresses this need by providing a device that can efficiently capture greenhouse gas emissions and convert them into valuable products and information.

Prior carbon capture methods and devices have focused primarily on the capture and storage of greenhouse gases to prevent their release into the atmosphere. While these techniques have been effective in reducing emissions, they have not addressed the potential to convert these captured gases into valuable industrial products. Current CCS methods involve the transportation of captured gases to a storage site, where they are stored indefinitely. This process is energy-intensive and does not provide any financial incentives for industries to reduce their emissions. Furthermore, traditional carbon capture technologies are often complex and expensive to implement, making them difficult for small or medium-sized businesses to adopt.

The present invention addresses these issues by providing a novel artificial intelligence technology that generated reactors to capture and convert greenhouse gas emissions into products, offering a more sustainable and economically viable solution to reducing greenhouse gas emissions through the use of a novel system of nanochannels with electrodes. The present invention favors the selectivity of the reactions and also allow the application of very high electric fields through ultrafast-pulses of dark plasma that can be controlled remotely by software.

Accordingly, an artificial intelligence system, device, and method for greenhouse gas capturing from the atmosphere, which is capable of converting these greenhouse gases into useful industrial valuable products, would offer a variety of benefits. Prior art mentions similar sections of the current system but without the same use and detailed structure. Additionally, the components mentioned in prior art do not work together to break down greenhouse gas components to produce predetermine products. Among the references of the topics of this invention, WO 2008/134871 provides an example of a carbon dioxide reactor in which it is possible to obtain hydrocarbons by electrolysis. A problem is that the patent only provides an example of a carbon dioxide reactor for the production of hydrocarbons by electrolysis, without providing specific details or a full description of the invention for predetermined products.

U.S. Pat. No. 6,806,778B1 discloses an arrangement of 3 transistors configuring both a Darlington and a cascode. However, the configuration is limited to only three transistors that configure both a Darlington and a cascode, and it does not address other limitations or challenges associated with Darlington transistors or transistor drive circuits more broadly. On the other hand, CN206878798U describes a kind of Darlington transistor drive circuit with extra components, but the structure differs from the present invention because it is focused towards the circuit and the overall technology described in the present invention.

US20170321333 A1 describes an electrochemical reactor for the reduction of carbon dioxide (CO₂) into hydrocarbons using a membrane-electrode assembly (MEA). However, it is limited to the reduction of CO₂ into hydrocarbons through the use of this type of electrochemical reactor. In U.S. Pat. No. 7,855,603B1 Temperature-compensated self-bias Darlington pair amplifier, an array consisting of two Darlington arrays is disclosed, where the first is a general-purpose array. As the patent states, the stability of these arrays can be affected by changes in temperature. To solve this, a second Darlington array is proposed that self-compensates for deviation due to temperature. The present disclosure is directed toward overcoming one or more of the problems discovered by the inventor, and introducing a functioning artificial intelligence system towards the present technology.

### SUMMARY

In an embodiment, a greenhouse gas capture and conversion system, the system comprises: a greenhouse gas intake device configured to receive intake gases; a nano filter separation device configured to receive the intake gases and to separate main components of the intake gases; a nano electro reactor system configured to receive the main components from the nano filter separation device and produce one or more products and geoatmospheric information from the main components received from the nano-filter; and an artificial intelligence system configured to self-repeat data to formulate design solutions using the geoatmospheric information provided by the NERS.

In an embodiment, a nano electro reactor system, the system comprises: a nano membrane; at least two electrodes, a cathode and anode, covered with a material developed for electrocatalysis with nano pulses of a high electrical field; and a gas plasma between said cathode and anode.

In an embodiment, a carbon capture and conversion device, the system comprises: a nano filter including: a polymethyl methacrylate, graphitic components, or metal-organic frameworks support; a micrometric sealant film; a filament electrode system with a first anode and a first cathode between said micrometric sealant film and polymethyl methacrylate, graphitic components, or metal-organic frameworks support; and a membrane with nano pores; and a nano electro reactor system that includes: a nano membrane, at least two electrodes, a second cathode and a second anode covered with a material developed for electrocatalysis with nano pulses of a high electrical field, and a gas plasma between said cathode and anode.

In an embodiment, a method for capturing and converting greenhouse gases from the atmosphere and other sources comprises: intaking greenhouse gases; separating main components of the intake gases using a nano filter separation device; producing, by a nano electro reactor system (NERS), carbon-based products from the separated main components; and filtering, by a secondary nano filter separation device, byproduct gases from an output stream of the NERS.

In an embodiment, a design, modeling, and artificial intelligence system, the system comprises: at least one processor and at least one memory configured to implement a learning network model, the learning network model generated from a training network, wherein the training network is tuned using user input from a greenhouse gas capture and conversion system, and wherein a specific gas or chemical compound intake associated with each of the labeled reference modeling of the system and components indicate the features associated with said modeling system prototype.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a flow diagram of the total CO₂ capture and conversion process;

FIG. 2 illustrates an electric field versus the current intensity diagram, which shows the dark plasma discharge zone;

FIG. 3 illustrates the CO₂ concentration depletion in parts per million as a function of time;

FIG. 4A illustrates a detailed design of electrodes optimized for maximum diffusion across the holes and maximum exposed electrode surface area;

FIG. 4B illustrates the components of the electrode system following the new assembly process;

FIG. 5 illustrates the pressure drop as a function of the hole diameter for the nanomembrane assembly and the design of the electrodes;

FIG. 6 illustrates the design of the nanomembrane, where the electric field is maximized by the edge effect in each pore;

FIG. 7 illustrates a schematic representation of the separation of the main molecules of air with dielectrophoretic technology using a novel nano filter separation device;

FIG. 8 illustrates the Avalanche Bipolar Junction Transistor (ABJT) and Insulated Gate Bipolar Transistor (IGBT) assembly, both conforming to the ABI Darlington and their secondary components;

FIG. 9 illustrates the current split into the ABI Darlington group;

FIG. 10 illustrates voltage profiles Vge and Vout;

FIG. 11 illustrates an improved driver diagram;

FIG. 12 illustrates the scaled system where the gas inlet to the electrode shell is axially fed and distributed in parallel to each cell, which are connected to the nanopulse or picopulse and femto-pulse generator; and

FIG. 13 illustrates a schematic representation of the artificial intelligence system to develop NERS solutions.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

The invention comprises an artificial intelligence, method and device that captures CO₂ and other greenhouse gases from sources such as air, transport gases and industrial facilities. As an initial step, nanoelectrospray gas phase dielectrophoretic mobility molecular technology (nES GDMMS) is used to separate particles and air molecules in the gas phase according to their differential mobility and size. The process consists of applying a variable and non-homogeneous electric field that induces charges in the particles or molecules of the sample, which causes them to charge. The charged molecules are then propelled through a gas phase, where they are classified based on their size and charge using a combination of techniques, including electrospray (ESI), gas-phase electrophoresis, and dielectrophoresis.

In the next stage, the invention preferably converts CO₂ into carbon compounds, ionizing the air molecules to form a dark plasma by applying electrical nano-pulses that promote the activation of the carbon dioxide molecule. The plasma may be located between a cathode and an anode. By capturing and converting CO₂ into useful carbon compounds, this process can potentially reduce the amount of carbon dioxide in the atmosphere, thereby helping to mitigate greenhouse gas emissions that may contribute to climate change. The advantages of the method and the device are decreasing energy costs by using the carbon compounds produced by this process as a fuel source, which can potentially reduce dependence on fossil fuels. In addition to reducing CO₂ emissions, this process can also potentially be used for environmental cleanup by converting other greenhouse gases, such as methane, into usable carbon compounds for an easy scalability, and producing chemical feedstocks with high market value.

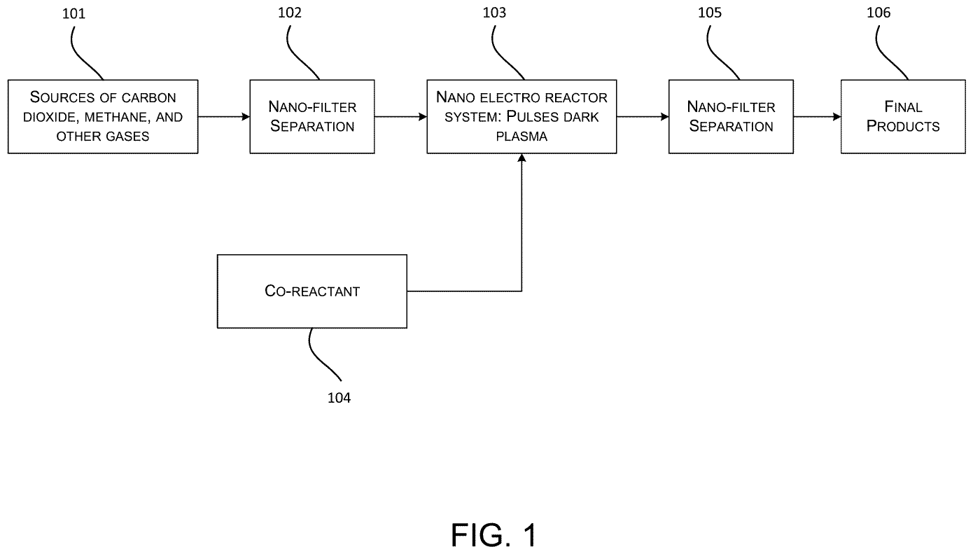

FIG. 1 illustrates a flow diagram of the total CO₂ capture and conversion process. The process operates by intaking sources of carbon dioxide, methane and other gases 101, then delivering a gas stream as an input to nano filter separation device 102 for gas separation. Sources of carbon dioxide, methane and other gases 101 that are filtered by the nano filter separation device 102 is the input gas stream to nano-electro reactor system 103 where products such as carbon-based compounds and information (sense) are produced. Alternatively, co-reactant 104 may be used, and it is possible to obtain other reaction products. Then, the output stream of nano-electro reactor system 103, is fed into a secondary nano filter separation device 105. Final products 106 are delivered to a process plant which follows a different process to obtain different valuable products.

The capture and conversion process comprise an intake of sources of carbon dioxide, methane and other gases 101. Sources of carbon dioxide, methane and other gases 101 CO₂, N₂, O₂, and H2O, contained in the atmospheric air is a prior stage to the reduction of carbon dioxide in the reactor. Intake is typically achieved through the use of an intake form, which is a document that captures information about the greenhouse gases being captured, including the type of gas, the source of the gas, and the quantity of gas being captured. The intake may be achieved through a greenhouse gas intake device configured to receive intake gases. The intake form is used to ensure that the capture and conversion process system is properly designed and operated to capture the specific greenhouse gas being emitted, and to accurately measure the amount of greenhouse gas being captured.

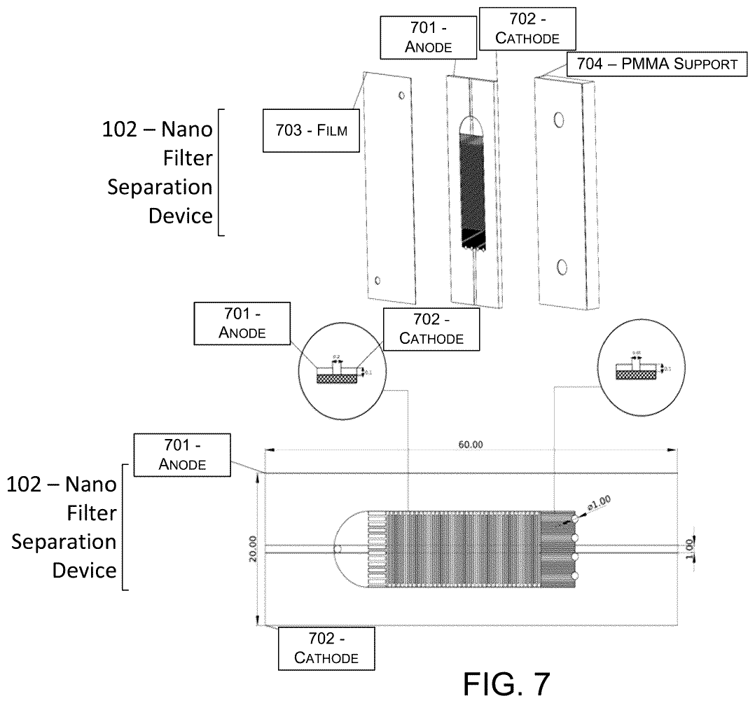

The capture and conversion process further comprise a nano filter separation device 102. The separation is realized using one or more novel nano filter which allow the separating of the molecules by migration under the effect of a high pulsed electric field via dielectrophoresis (DEP). Nano filter separation device 102 may be configured to receive the intake gases and to separate main components of the intake gases. The novel nano filter separation device 102 consists of an airflow that enters a device that separates the main compounds, under the effect of an electric field applied to the gas phase, the induction of changes in the species occurs. The species migrate differing by size and are directed to a dividing device where they are separated into their main components, as shown below in FIG. 7. Due to the distribution of electrodes and the working frequency of the nano filter separation device 102, the speed of gas separation is improved compared to other processes. A high pulsed electric field (hPEF) promotes the activation and conversion of carbon dioxide, methane and other gases into carbon compounds and hydrogen according to the case. The electric field energy which is applied may come from renewable energy sources, such as solar panels.

Further, the capture and conversion process comprises a nano electro reactor system (NERS) 103. Preferably, NERS 103 is associated with a greenhouse gas capture and reaction device and information and may be configured to receive the main components from the nano filter separation device to produce one or more products and geoatmospheric information. NERS 103 breaks molecules coming from nano filter separation device 102 and delivers a new structure in the molecule. The type of structure desired will trigger which NERS 103 is preferred. NERS 103 will deliver final products 106 depending on several variables, such as the arrangement of the electrodes, centrifugal process, microreactor, physical process that can vary, temperature, type of molecule. Even that a preferred structure for NERS 103 is described, NERS 103 can comprise nanoelectrode arrays which are systems consisting of multiple small electrodes, typically with diameters ranging from tens to hundreds of nanometers, arranged in an array. They can be used for electrochemical sensing, biosensing, information geoatmospheric and electrocatalysis. Also, can include nanoparticle-based reactors which are systems that use nanoparticles, typically metal or metal oxide nanoparticles, as catalysts to promote electrochemical reactions. They can be used for energy storage and conversion, such as in lithium-ion batteries or fuel cells. Additionally, NERS 103 can be based on electro spun nanofiber reactors which are systems consisting of electro spun nanofibers, which have high surface area and porosity, as the reactive material. They can be used for water treatment, such as removing pollutants or producing hydrogen peroxide. Finally, NERS 103 can include Carbon nanotube reactors which are systems that use carbon nanotubes, which have high electrical conductivity and surface area, as the reactive material. They can be used for electrochemical sensing, energy storage, and catalysis.

Preferably, NERS 103 consists of at least two electrodes, a nano membrane, cathode and anode, covered with a material developed for electrocatalysis with nano-pulses of a high electrical field. Additionally, it comprises gas plasma between cathode and anode. NERS 103 can include a gas sensor to measures concentration in real-time, following the decay or increase inside the reactor, and an infrared camera focused on the electrodes area records temperature changes in the reaction area. Finally, it can also include a spectrophotometer for discharge monitoring.

NERS 103 contains a novel plurality of nanochannels with electrodes. The process for NERS 103 operation initiates with the intake of sources of carbon dioxide, methane and other gases 101 and the electrodes connected to an energy source. The nano-pulse electric field is applied between electrodes and provides the energy necessary to generation of dark plasma from the gas source and produce preferably graphene oxide and hydrogen according to the case.

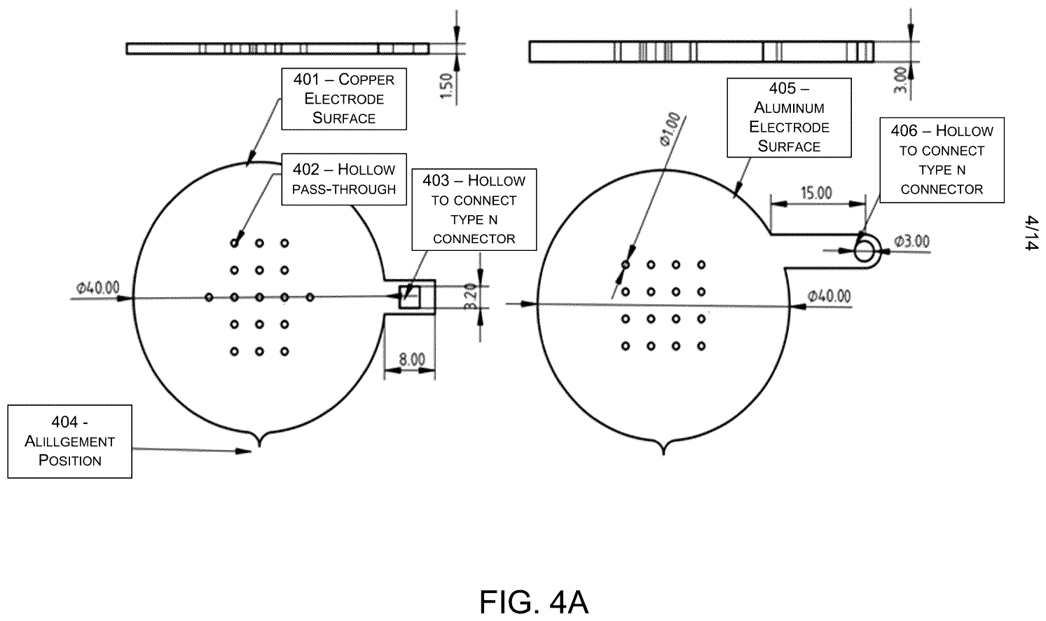

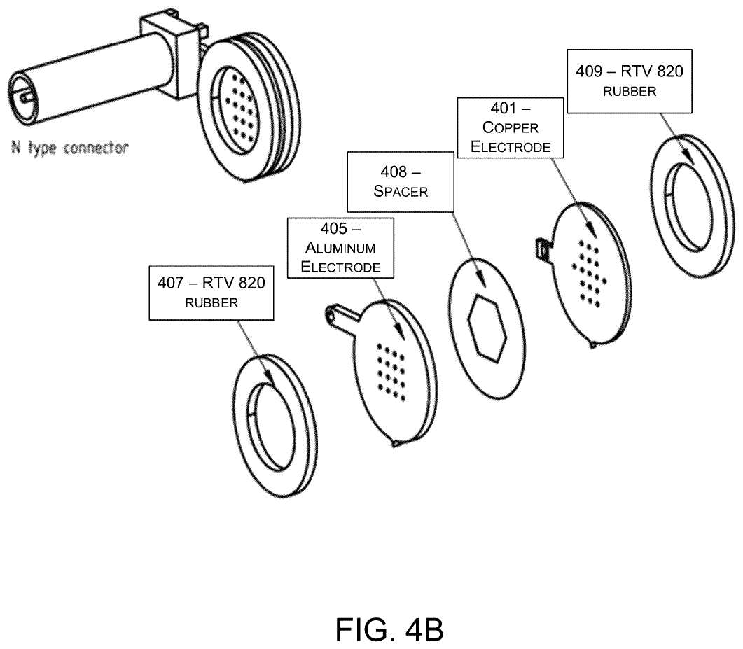

NERS 103 components are manufactured with specific materials that favor the selectivity of the reactions and also allow the application of very high electric fields (ultrafast-pulses of dark plasma). The capture and conversion system electrodes are optimized for maximum diffusion and maximum exposed electrode surface area. As an example, the electrodes can have holes with a diameter of 1 nm with a number of holes for a couple of electrodes of 16 and 17 respectively, and the center to center distance of the holes as 4 nm, as shown in FIG. 4A. The perforated area concerning the total area of the electrode is 4.25%. The electrode materials are specifically developed for electrocatalysis, and are highly selective for each reaction. Metals are used as electrocatalysts, preferably Cu-based, stainless steel-based, Ni/Sn based, and Al-based materials.

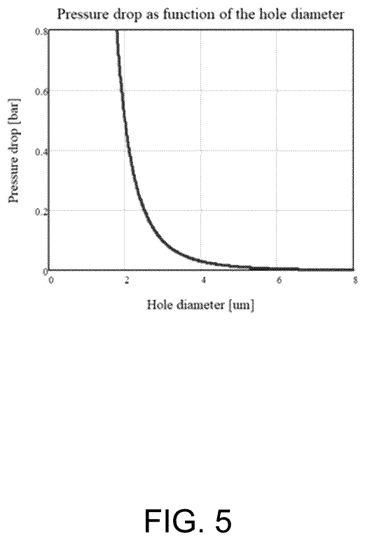

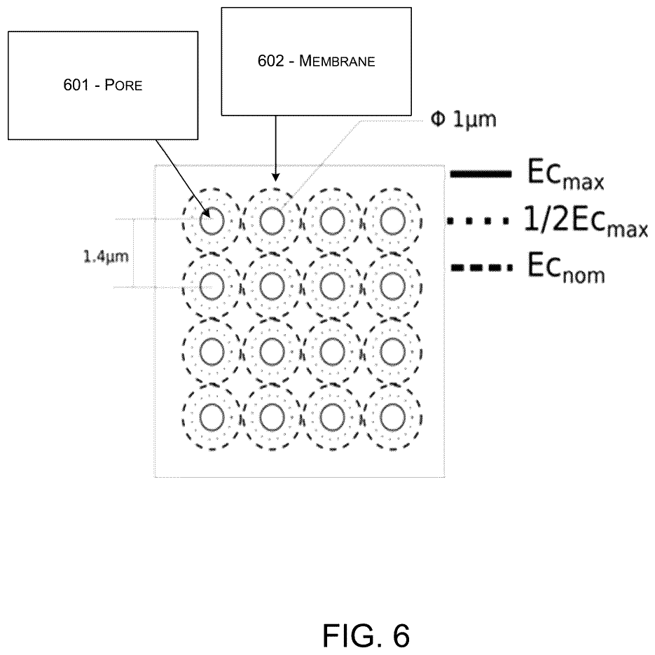

NERS 103 can use a novel nanomembrane design that allows fluid flow through an optimized arrangement of nano-porosities as shown in FIG. 6. The optimization is based on the pressure drop across the holes, as shown in FIG. 5. As in the case of the electrodes, the nano-porosities arrangement maximizes the diffusion and the exposed surface area, as well as intensifies the effect of nano-pulses of high electric fields. Additionally, electrodes can be assembled out of alignment, such that the holes in each electrode allow the gas stream to flow through them, achieving maximum diffusion and maximum exposed electrode surface area.

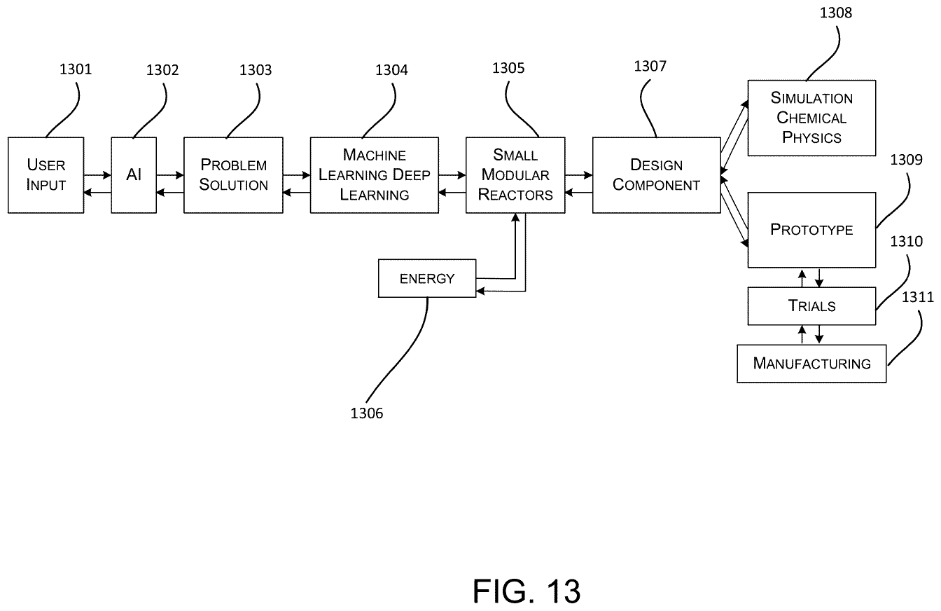

NERS 103 can be portable and modular for home use or it can be scaled up to be applied in the power industry. Therefore, a network of NERS 103 distributed throughout the world is generated, it constitutes a system guided by artificial intelligence to develop NERS 103 solutions adapted to the real demand and at the same time allows obtaining an instantaneous real-time atmospheric and industrial gases image of the world, as shown in FIG. 13. Additionally, this invention relates to new developments in electronic devices, specifically picosecond and nanosecond pulsed electric field (PEF) generators that can be controlled remotely by software.

Alternatively, the capture and conversion process can comprise a co-reactant 104, and it is possible to obtain other reaction products. Co-reactant 104 is used to fuel different modules to promote conversion to different carbon compounds using greenhouse gases as the main precursors. A co-reactant 104 is a substance that is added to NERS 103 to facilitate and improve the electrochemical reaction that takes place within it. Co-reactant 104 typically consists of a nanoscale electrode and an electrolyte solution, which are used to carry out electrochemical reactions at the nanoscale level. The function of co-reactant 104 is to help improve the overall efficiency and effectiveness of these reactions. It does this by enhancing the electrochemical properties of the system, such as increasing the rate of electron transfer, facilitating ion transport, and reducing the amount of energy required to drive the reaction. As an example, co-reactant 104 that can be used in NERS 103 is a redox mediator. This type of substance is used to mediate electron transfer between the electrode and the electrolyte solution, which can help to improve the overall efficiency of the system.

The capture and conversion process further can comprise a secondary nano filter separation device 105. As nano filter separation device 102, the separation is realized using one or more novel nano filter separation device 102 which allow the separating of the molecules but with a focus on solids. The novel secondary nano filter separation device 105 consists of the intake coming from NERS 103. The species migrate differing by size and are directed to a dividing device where they are separated into their main components, as shown below in FIG. 7. Due to the distribution of electrodes and the working frequency of the secondary nano filter separation device 105, the speed of gas separation is improved compared to other processes. A high pulsed electric field (hPEF) promotes the activation and conversion of carbon dioxide, methane and other gases into carbon compounds and hydrogen according to the case.

Furthermore, the process can be connected to the cell phone and everything is managed by the cell phone through sensors to detect things on equipment or in the environment to monitor improvement for develop simulation software, and design according to environmental specifications

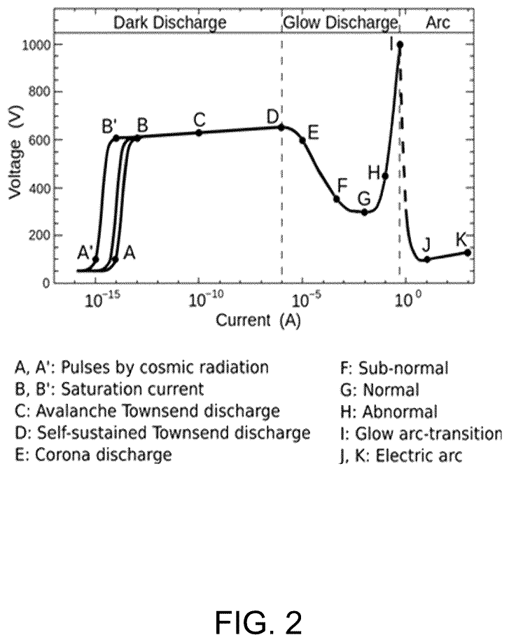

FIG. 2 illustrates an electric field versus the current intensity diagram, which shows the dark plasma discharge zone. Most preferably, the nano-electro reactor operates in the dark air plasma zone. The method and system operate in the dark discharge zone, more specifically in the cold plasma zone which corresponds to non-thermal plasma. Cold plasma is a partially ionized gas which consists of ions, electrons, neutral particles such as radicals, excited, and ground-state molecules. The main peculiarity of cold plasma consists of the significant difference between the temperature of ions, neutral particles and electron temperature. As for ions and neutral particles, it is close to room temperature between 25 and 100° C., while electron temperature is higher, between 500° and 105° C. This thermal property is what the invention takes advantage of. The invention makes it possible to improve energy efficiency of capture and conversion of carbon dioxide, methane and other gases with respect to other technologies.

In this zone, the electrons in the plasma are no longer able to gain enough energy from the electric field to ionize the gas molecules. As a result, the ionization rate decreases, and the plasma density decreases, leading to a decrease in the current intensity. At the same time, the decrease in electric field strength means that the energy transferred to the electrons is not enough to cause them to emit visible light, resulting in the disappearance of the glow. The dark plasma discharge zone is an important characteristic of plasma discharges, as it represents the limit of the glow discharge regime. In other applications and methods, the plasma discharge becomes unstable and transitions to a different regime, such as the arc discharge regime. However, in the present invention, the nano-electro reactor operates in the dark air plasma zone and is able to improve energy efficiency of capture and conversion of carbon dioxide, methane and other gases with respect to other technologies

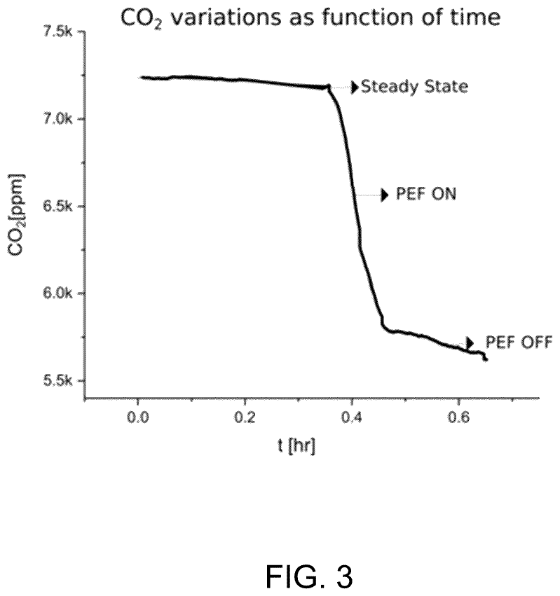

FIG. 3 illustrates the CO₂ concentration depletion in parts per million as a function of time. The invention makes possible to improve energy efficiency of capture and conversion of carbon dioxide, methane and other gases with respect to other technologies. The FIG. 3 demonstrates the temporal profile of carbon dioxide concentration in a hydrogen containing gas mixture. As it can be seen, the concentration of carbon dioxide decreases with time. This device uses a module fueled with hydrogen as a co-reactant. Tests such as those corresponding to FIG. 3. can use 100 to 500 ns as PEF ON time, while the PEF OFF time can be 100 ms to 1 s.

FIG. 4A illustrates a detailed design of electrodes optimized for maximum diffusion across the holes and maximum exposed electrode surface area. Another embodiment of the invention is a detailed design of electrodes optimized for maximum diffusion and maximum exposed electrode surface area as shown in FIG. 4A The electrode design consists on a copper electrode surface 401 that contains a series of hollow pass-through 402 embodiments and a hollow to connect type n connector 403. Similarly, a second electrode structure consist of aluminum electrode surface 405 and connected through a hollow to connect type n connector 406. Both structures are aligned through alignment position 404.

This embodiment includes a novel nanopore assembly and fabrication process that is applicable to both nanomembranes and electrodes. In the manufacturing process, the nanopores of the solid-state membranes are obtained by controlled dielectric breakdown. In the fabrication system, a voltage is applied on a membrane immersed in an aqueous salt solution to generate a high electric field. These nanopores can be made as small as 1 nm in diameter. There are other techniques used to generate nanopores in films such as membranes. While the electrodes are assembled out of alignment, such that the holes in each electrode allow the gas stream to flow through them, achieving maximum diffusion and maximum exposed electrode surface area.

FIG. 4B illustrates the components of the electrode system following the new assembly process. Another embodiment of the invention is a detailed design of electrodes optimized for maximum diffusion and maximum exposed electrode surface area as shown in FIG. 4B with the additional components that constitute the novel assembly process. The electrode design consists on a copper electrode surface 401 and a second electrode structure consist of aluminum electrode surface 405 are separated by a spacer 408. Both electrodes copper electrode surface 401 and aluminum electrode surface 405 lay between Room Temperature Vulcanizing 820 rubber 407 and Room Temperature Vulcanizing 820 rubber 409.

FIG. 5 illustrates the pressure drop as a function of the hole diameter for the nanomembrane assembly and the design of the electrodes. The nanomembrane has the diameter of the holes optimized by the pressure drop and such a curve is shown in FIG. 5. The pressure drop in a nanomembrane assembly can be influenced by several factors, including the size of the holes in the membrane and the design of the electrodes. As the diameter of the holes in the membrane decreases, the pressure drop across the membrane increases, due to increased resistance to flow. This means that smaller holes can lead to higher pressure drops, which can affect the efficiency of the system. On the other hand, the design of the electrodes can also affect the pressure drop, as the distance between the electrodes can influence the flow of the fluid through the membrane. A shorter distance between the electrodes can lead to a lower pressure drop, as it reduces the resistance to flow.

FIG. 6 illustrates the design of the nanomembrane, where the electric field is maximized by the edge effect in each pore. A further embodiment of the invention is a device and preparation method of a nano membrane-electrode assembly which can be used for gaining electrochemical selectivity in several reactions. A novel design of nanomembranes consisting of a specific assembly of electrodes has been developed. This nanomembrane can be used in the nano-electro reactor system (NERS) to intensify the effects of the high electric field nano-pulses. Further, electric field may be applied within the membrane 602 to create an electro precipitation effect to separate solids. A schematic view of the nanomembrane design consists of a pore 601 and membrane 602.

FIG. 7 illustrates a schematic representation of the separation of the main molecules of air with dielectrophoretic technology using a novel nano filter separation device. Nano filter separation device 102 comprises a polymethyl methacrylate (PMMA), graphitic components, or metal-organic frameworks support 704; a micrometric sealant film 703; a filament electrode system with an anode 701 and cathode 702 between said micrometric sealant film and polymethyl methacrylate, graphitic components, or metal-organic frameworks support; and a membrane 602 with nano pores 601 (see FIG. 6). The top image of FIG. 7 represents an exploded view of the molecule separation process through the nano filter separation device 102. The image below FIG. 7 represents a plan view of the structure in the molecule separation process through the nano filter separation device 102.

The capturing system comprises a novel nano filter separation device that allows the separating of the air molecules by migration under the effect of a high pulsed electric field via dielectrophoresis. FIG. 7 shows a schematic representation of the separation of molecules with dielectrophoretic technology. Nano filter separation device 102 works as follows, the gas stream fed by the inlet, is distributed and comes into contact with the filament electrodes among which the plasma is produced by Dielectric Barrier Discharge. The separation of different gases is achieved by applying of magnetic fields after the formation of the plasma, directing each gas according to the ionic mobility of each chemical species.

Polymethyl methacrylate (PMMA), graphitic components, or metal-organic frameworks support 704 is a versatile polymer used in a variety of applications, including as a support material. Depending on the design requirements, PMMA support 704 may vary. There are different types of PMMA support 704 that can be used for different application requirements. Solid PMMA support 704 can be used for their high strength and rigidity. Porous PMMA support 704 are designed to be porous and are used for applications such as filtration, separation, and chromatography. Thermally conductive PMMA support 704 can be used for designs that require to have high thermal conductivity and are used in applications where heat dissipation is important.

Micrometric sealant film 703 is used to provide a thin layer of sealant to a surface, ensuring that it is protected from moisture, air, or other environmental factors. There are different types of sealant film 703 that can be used for different application requirements. Filament film 703 types include, but are not limited to PTFE, silicone, polyutherane, epoxy, and acrylic materials.

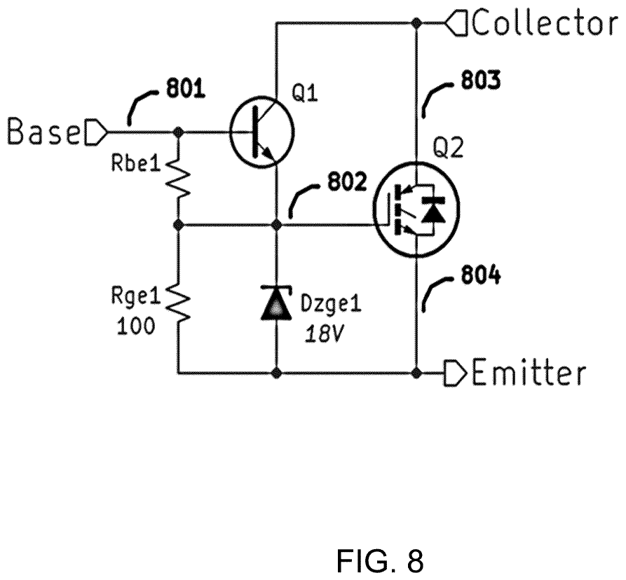

FIG. 8 illustrates the Avalanche Bipolar Junction Transistor (ABJT) and Insulated Gate Bipolar Transistor (IGBT) assembly, both conforming to the ABI Darlington and their secondary components. The assembly depicts input base 801 connected to 803 collector and 804 emitter equivalents terminals. Additionally, resistor Rbe1 is for correct polarization in the avalanche region, avoiding auto-trigger issues of the Q1 device. Respecting Rge1, it allows a drop down the input impedance of the Q2 transistor in the node 802, giving certain safety against the massive current flowing from Q1 to node 802. Furthermore, during the turn-off device event, it allows an easy Q2 parasitic capacitance discharge. Finally, the Dzge1 diode is for protection matters, but this is not working in normal operation, at least an over-peak input Q2 voltage appears.

Related to the novel development of the electronic section of the device, which consists preferably of an ABI Darlington driver, there are currently several proposals for Darlington variants, each with its advantages and benefits. Preferably, the arrangement consists of 3 transistors configuring both a Darlington and a cascode. The configuration improves the breaking strength of the cascode assembly, the thermal stability, and the bandwidth. The nano-electro reactor system comprises drivers to generate pulsed dark plasma. FIG. 8 represents the Avalanche Bipolar Junction Transistor (BJT) and IGBT (named as ABI) Darlington and their secondary components. In an avalanche breakdown, the reverse-biased collector-base junction of the transistor experiences a high electric field, causing the electrons in the junction to gain enough energy to collide with other atoms and create additional electron-hole pairs. These newly created carriers then gain energy and collide with more atoms, creating a chain reaction that rapidly multiplies the number of carriers in the junction.

This process can result in a large increase in the collector current of the transistor, leading to potential device failure if not properly controlled. However, it can also be harnessed for certain applications, such as in avalanche photodiodes, which use avalanche breakdown to amplify and detect light signals.

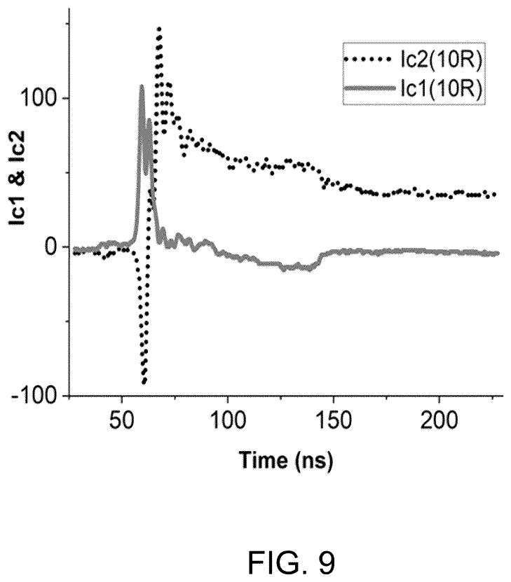

FIG. 9 illustrates the current split into the ABI Darlington group. A short time current pulse Ic1 is into the avalanche BJT Q1 (solid plot), meanwhile, a large time current Ic2 is thought by the IGBT Q2 device (dotted plot). Its due input control voltage in input base 801 first triggers the ABJT Q1 device, giving a high and short current pulse Ic1. After that, this Ic1 raises node 802 input IGBT Q2 voltage, turning it on. Activation of Q2 allows an increment of the device current Ic2 and dropping down the Vce (collector 803-emitter 804) to VceON voltage. This low Vce voltage gets out to Q1 from the avalanche region to the saturation zone, shutting them down.

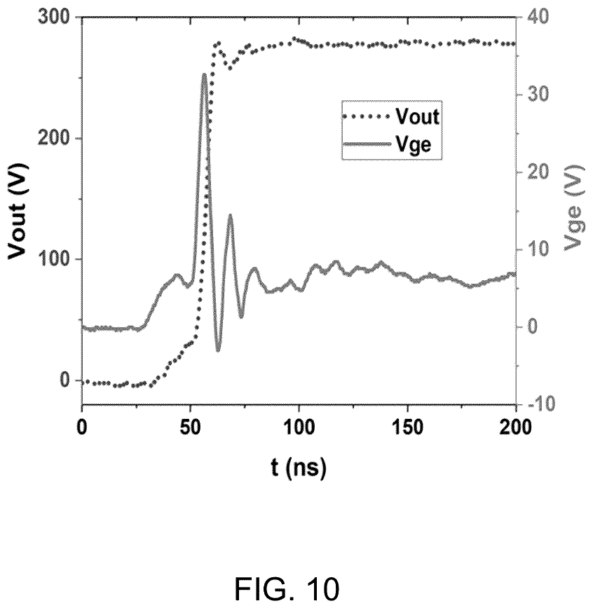

FIG. 10 illustrates voltage profiles Vge and Vout. Vge, or gate-to-emitter voltage, is the voltage applied across the gate and emitter of a transistor. This voltage controls the flow of current through the transistor, allowing it to act as a switch or amplifier. Vout, or output voltage, is the voltage measured at the output terminal of a circuit. The relationship between Vge and Vout depends on the specific circuit configuration and the characteristics of the transistor used. Note Vge triggers Ic2 immediately into the Q2 transistor. This raises the output voltage to about 10 ns approximately.

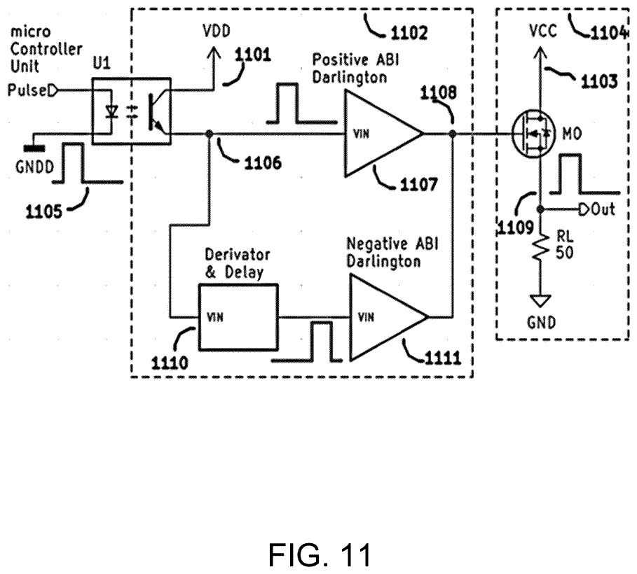

FIG. 11 illustrates an improved driver diagram. It consists of two ABI Darlington arrangements (1107 and 1111) in the driver output (1108). That is used in turns to activate and deactivate the power external transistor MO. Driver circuit 1102 is controlled by optocoupler U1, providing in their output 1106 a single control pulse. This is used to activate the 1107 ABI Darlington with their positive edge pulse change, and with this, turn on the output power transistor MO. The negative edge of optocoupler pulse 1106, is used in the 1110 subcircuit to activate the second ABI Darlington 1111, set down the driver output 1108, and then turn off the MO transistor. At the same time, 1106 optocoupler voltage shut down the 1107 ABI Darlington. Respect 1101, this is part of a floating auxiliary power supply for the driver 1102 system and must have a minimal value to allow the ABJT Q1 in FIG. 8 move to the avalanche zone. On the other hand, 1103 is the main high power supply (800V for example), to polarize MO and RL output circuit (1104).

Another embodiment of the invention is a device that enables a control of high-energy pulses at nanosecond time scale consisting of an ABI Darlington driver. An ABI (Active Balanced Interface) Darlington driver is an electronic component used to interface between digital circuits and high-power devices, such as motors or solenoids. It consists of a Darlington pair transistor configuration that provides high current gain and high input impedance, making it suitable for driving loads that require significant current or voltage.

The ABI Darlington driver is designed to provide a balanced output, which means that the voltage swing between the output and the ground is equal to the voltage swing between the output and the supply voltage. This balanced output helps to reduce electromagnetic interference (EMI) and noise in the system.

The ABI Darlington driver can be used in a variety of applications, such as in motor control circuits, power supplies, and audio amplifiers. It is a popular choice for high-power switching applications where a low-power signal needs to control a high-power device.

This modified Darlington drastically decreases the rise time of the slow IGBT/MOS to almost ten nanoseconds. In addition to this, another Darlington array can be used to drastically reduce the fall time as well. Additionally, the transition power of the IGBT/MOS (at the rise time) is consumed by the avalanche bipolar transistor, and it works very similarly with both IGBTs and MOS-FETs. Turning on the IGBT/MOS it immediately turns off the avalanche bipolar transistor. Moreover, the shutdown of the Darlington array enables the repeatability of the pulses, which allows it to be used in switched sources. The described improvements were observed using common and cheap components and applied to modern and faster devices such as SiC or GaN the results would be even more significant.

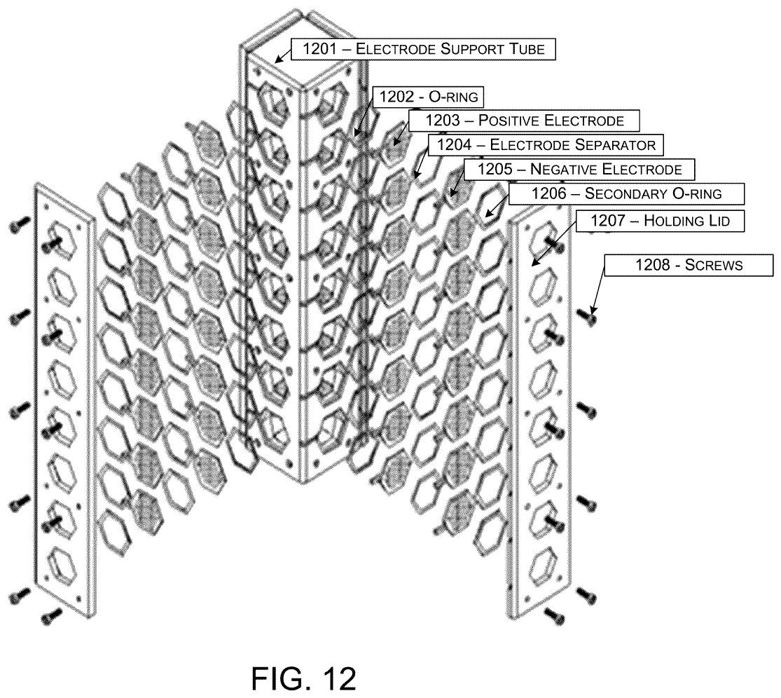

FIG. 12 illustrates the scaled system where the gas inlet to the electrode shell is axially fed and distributed in parallel to each cell, which are connected to the nanopulse or picopulse and femto-pulse generator. According to the embodiment, the scaled-up system comprises an electrode support tube 1201, followed by an o-ring 1202, positive electrode 1203, electrode separator 1204, negative electrode 1205, secondary o-ring 1206, holding lid 1207, and secured by screws 1208 that connect to electrode support tube 1201. The scaled-up system of capture and conversion of greenhouse gases constitutes another embodiment of the invention, FIG. 12 shows the design of the electrodes shell, the scaled up system consists of 84 cells in parallel, whose power is 4 kW and the inlet flow of the gas to be treated is 560 ton/yr. The electrodes are spaced on the microscale and the holes of each electrode are spaced on the millimeter scale. Each of the electrode shell shown can be fixed in parallel and stack, through a gas distribution system.

FIG. 13 illustrates a schematic representation of the artificial intelligence system to develop NERS 103 solutions. The system guided by artificial intelligence to develop NERS 103 solutions adapted to the real demand is another embodiment of the invention. FIG. 13 shows a schematic representation of the components that integrate it. The user communicates user input 1301 with an artificial intelligence (AI) 1302, which interprets and extracts the information of the problem in the problem solution 1303 phase. Further, the artificial intelligence system may be configured to self-repeat data to formulate design solutions using the geoatmospheric information provided by the NERS. In machine learning/deep learning 1304, the AI defines the components of the greenhouse gas capture and conversion system, based on the problem that needs to be solved. This process may be defined as a learning network model. The configuration of the solution begins with the modeling of the system, essentially the reactor, using machine learning/deep learning 1304. The physics and chemistry of the system components are simulated under simulation 1308 in order to find the optimal operating parameters in small modular reactors 1305, which allow defining its design and components under design component 1307. The process of trial and tests may be referred as a training network that has as a purpose to find the optimal parameters for prototype 1309. Prototype 1309 is built to start the necessary iterative tests, until reaching the final prototype 1309. The intake values for the tests may come from small modular reactors 1305. After prototype 1309 is complete, trials 1310 can continue to verify its performance that finishes defining the parameters and the design, to start the iteration with the prototype 1309, the tests and the final prototype 1309 for manufacturing 1311. The results may be used to model a scaled-up greenhouse and conversion system to design the electrode shell, where the gas inlet of the electron shell may be axially fed and distributed to each cell.

What is claimed is:

1. A greenhouse gas capture and conversion system by plasmalysis, comprising:
a greenhouse gas intake device configured to receive intake gases;
an external source of co-reactants;
a first nano filter separation device configured to receive the intake gases and to separate main components of the intake gases;
a nano electro reactor system (NERS) configured to receive the main components from a nano filter separation device and produce one or more products;
a second nano filter separation device configured to receive an output stream of NERS and filter byproduct gases and solids from the one or more products; and
a nano-pulse and pico-pulse and femto-pulse generator.

2. (canceled)

3. (canceled)

4. (canceled)

5. The system of claim 1, wherein the first nano filter separation device comprises:
a polymethyl methacrylate, graphitic components, or metal-organic frameworks support;
a micrometric sealant film;
a filament electrode system with an anode and cathode between said micrometric sealant film and polymethyl methacrylate, graphitic components, or metal-organic frameworks support; and
a gas stream containing greenhouse gases to be treated, in contact with the filament electrode system.

6. (canceled)

7. The system of claim 1, wherein, in the first nano filter separation device, a high pulsed electric field between electrodes promotes separation of gas into its components due to migration by electrophoretic effect.

8. The system of claim 1, wherein a gas or liquid stream fed from an external source of co-reactants enters, and the gas stream fed from an outlet of a first nano filter separation device, come into contact with electrodes into the NERS, where reactions are carried out using plasmalysis technology.

9. The system of claim 1, wherein the secondary nano filter separation device comprises:
a polymethyl methacrylate, graphitic components, or metal-organic frameworks support;
a micrometric sealant film;
a filament electrode system with an anode and cathode between said micrometric sealant film and polymethyl methacrylate, graphitic components, or metal-organic frameworks support; and
a gas stream pretreated by the NERS and in contact with the filament electrode system.

10. (canceled)

11. (canceled)

12. (canceled)

13. The system of claim 45, further comprising:
a gas sensor configured to measure a given concentration of gases in real-time, following a decay or increase inside the nano electro reactor system;
an infrared camera configured to focus on an electrode reaction area to record temperature changes; and
a spectrophotometer configured to measure a discharge monitoring.

14. The system of claim 45, wherein NERS components are manufactured with materials that favor selectivity of reactions and also allow an application of very high electric fields.

15. The system of claim 45, wherein a design of the electrodes maximizes an electric field created by an edge effect in each pore.

16. The system of claim 45, wherein the electrodes are spaced apart at a distance sufficient to increase energy efficiency in plasma generation through a field effect.

17. The system of claim 45, wherein the electrodes are mobile.

18. The system of claim 45, wherein the electrodes are fixed.

19. The system of claim 45, wherein the electrodes are at a predetermined distance.

20. The system of claim 45, wherein the system operates in a cold plasma zone.

21. The system of claim 45, wherein the electrodes are electrically connected to a nano-pulse, pico-pulse, and femto-pulse generator that allows an application of a high electric field.

22. The system of claim 45, wherein said electrodes are non-aligned, such that holes in each electrode allow gas stream to flow through them, achieving maximum diffusion and maximum exposed electrode surface area.

23. The system of claim 1, wherein the system can be controlled remotely by software.

24. The system of claim 1, wherein the nano-pulse, pico-pulse, and femto-pulse generator further comprises at least one Darlington driver to generate pulsed cold plasma.

25. The system of claim 24, wherein, in the nano-pulse, pico-pulse, and femto-pulse generator, shutdown of Darlington array allows repeatability of pulses, which allows it to be used in switched drivers.

26. The system of claim 24, wherein the nano-pulse, pico-pulse, and femto-pulse generator comprises:
a resistor configured to correct polarization an avalanche region; and
a resistor configured to drop down an input impedance and ease a parasitic capacitance discharge.

27. (canceled)

28. (canceled)

29. (canceled)

30. (canceled)

31. A method for capturing and converting greenhouse by plasmalysis, comprising:
intaking greenhouse gases;
intaking co-reactants from an external source;
separating main components of intake greenhouse gases using a nano filter separation device;
producing, by a nano electro reactor system (NERS), carbon-based products and gaseous products;
filtering, by a secondary nano filter separation device, byproduct gases from an output stream of the NERS; and
generating nano-pulse and pico-pulse and femto-pulse.

32. The method of claim 31, further including input of co-reactants of external sources into the NERS.

33. The system of claim 32, which includes inputting a gas or a liquid.

34. The system of claim 5, which includes a filament electrode system, wherein a high pulsed electric field between electrodes promotes a separation of gas into its components due to migration by electrophoretic effect.

35. The method of claim 31, wherein two streams enter the NERS; a gas or liquid stream that comes from an external source of co-reactants, and a gas stream that comes from the first nanofilter separation device, wherein both streams come into contact with the electrodes into the NERS, where reactions are carried out using plasmalysis technology.

36. (canceled)

37. The system of claim 45, which includes assembling electrodes out of alignment, such that holes in each electrode allow a gas stream to flow through them, achieving maximum diffusion and maximum exposed electrode surface area.

38. The system of claim 45, wherein NERS components are manufactured with materials that favor selectivity of reactions and also allow an application of very high electric fields.

39. The system of claim 45, wherein design of an electrode maximizes an electric field through an edge effect in each pore.

40. (canceled)

41. (canceled)

42. (canceled)

43. The method of claim 31, wherein small modular reactor results translate into scaled-up greenhouse and conversion system to design electrode shell.

44. The system of claim 45, wherein a gas inlet of an electrode shell is axially fed and distributed in parallel to each cell.

45. The system of claim 1, further comprising:
a nano electro reactor system, comprising:
at least two electrodes including a cathode and anode of aluminum and copper respectively, covered with an electrocatalytic material;
a micrometric spacer;
a rubber sealant;
a gas stream containing greenhouse gases to become plasma, in contact with said cathode and anode.

46. The system of claim 1, wherein the greenhouse gas to be treated is methane, is configured to produce solid carbon and gaseous hydrogen.

47. The system of claim 1, wherein the greenhouse gas to be treated is carbon dioxide, is configured to produce solid carbon, gaseous oxygen and other compounds such as graphene oxide.

48. The system of claim 1, further comprising external sources of co-reactants;
wherein such co-reactants are introduced into the NERS to carry out reactions by plasmalysis technology in the NERS using said co-reactants to obtain different reaction products coming from the NERS.

49. The system of claim 48, wherein a co-reactant source is a gas or a liquid.
